(19) United States
(12) Patent Application Publication
(10) Pub. No.: US 2018/0374135 A1
(43) Pub. Date: Dec. 27, 2018

(54) HOME DECORATIVE SYSTEM

(71) Applicants: Shawnna Evans, Hixson, TN (US); Deborah Pippin, Hixson, TN (US)

(72) Inventors: Shawnna Evans, Hixson, TN (US); Deborah Pippin, Hixson, TN (US)

(21) Appl. No.: 15/634,485

(22) Filed: Jun. 27, 2017

(51) Int. Cl. G06Q 30/06

(52) U.S. Cl. CPC G06Q 30/0621; H04N 1/00209

(57) ABSTRACT

A method of home decorating that include the steps of: taking a photo of a home with a portable electronic device; submitting the photo to an interactive platform; creating a lighting display with the interactive platform for projection onto the home; saving the lighting display onto memory; installing the lighting display into a projector for display purposes; and sending the projector to a user. The portable electronic device is a smartphone or a tablet. The lighting display is preferably adapted for modification after the step of installing the lighting display.

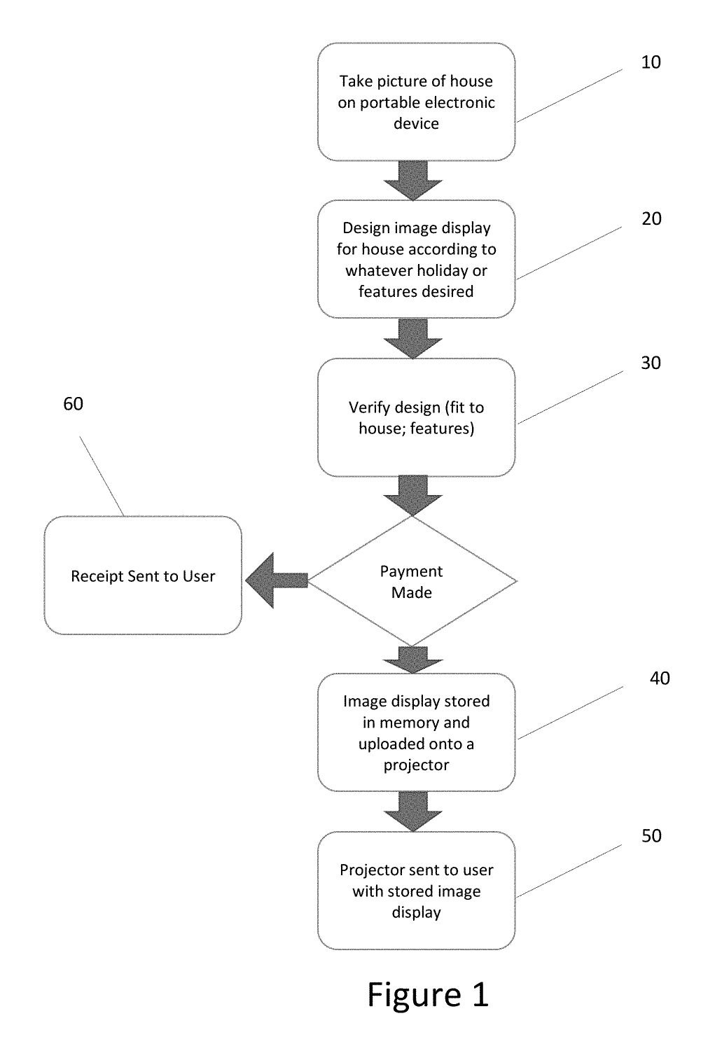

### BACKGROUND OF THE INVENTION

### Field of Invention

The present invention relates to a decorative system that's used to provide a projected image onto a home.

### Description of Related Art

Presently many individuals use lighting designs as a means to decorate their home for various holidays. This technique is especially true during the Christmas holidays where individuals project stars or snowflakes onto the exterior surface of their home to provide holiday festive decorations. Individuals also place lighting and other images near and around the home to provide holiday decorations. Further decorations are implemented on other holidays during the year such as Memorial Day, Independence Day and Halloween in particular. This gives the homeowners an opportunity to show their creativity and have an enjoyable pastime that could be enjoyed by themselves and neighbors. These decorations usually take a significant amount of time and generally require special lighting and imaging that must be arranged on the home. As a result, it would be advantageous to have a business system that could be implemented to provide lighting and imagery for a home consistent with the present desires of a homeowner.

### SUMMARY OF THE INVENTION

The present invention relates to a method of home decorating that include the steps of: taking a photo of a home with a portable electronic device; submitting the photo to an interactive platform; creating a lighting display with the interactive platform for projection onto the home; saving the lighting display onto memory; installing the lighting display into a projector for display purposes; and sending the projector to a user. The portable electronic device is a smartphone or a tablet. The lighting display is preferably adapted for modification after the step of installing the lighting display.

### BRIEF DESCRIPTION OF DRAWINGS

FIGURE One depicts a flowchart related to the steps implemented to create a home decorative projection.

### DETAILED DESCRIPTION

The present invention relates to a system, where an individual may use their portable electronic device such as a smart phone or tablet to take a picture of an existing home. This picture may then be uploaded to an interactive database that allows the user to design a lighting design that can be projected onto the home for decorative purposes. The system allows the user to use a photograph provided by the user on a web site or other interactive platform to design lighting imagery for the home. Once the imagery is complete a user pays for the design time and receives a projector that is sent to their residence. Once sent to their residence the projector projects the image onto the home as desired by the user. The user therefore has the opportunity to design the lighting and decorative imagery and then receive a projector that could be used on a regular basis or updated as desired by the user through the imagery system.

FIGURE One shows steps in a flowchart related to the present invention. Initially in Step 10, a user takes a photograph of a house using a portable electronic device. Next in Step 20, the picture is uploaded to an interactive platform and a design of the decorative features may be created by the user. Next under Step 30 the design may be verified by the user and modified as desired once complete. The interactive platform provides a preview of the image as projected onto the picture of the house provided by the user. Once approved the user makes payment, Step 40, wherein the user is sent an electronic receipt and the transaction is completed in the system. Once the transaction is completed the imagery is saved on a projector which is shipped to the user, Step 50. After the shipment the user receives the projector, Step 60 and may then follow directions on projecting the imagine onto the home.

This system according to the present invention is a business method that allows users to have interactive design of lighting imagery for their home. Such imagery is essential to the decorative designs of the user. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A method of home decorating comprising the steps of:
a. taking a photo of a home with a portable electronic device;
b. submitting the photo to an interactive platform;
c. creating a lighting display with the interactive platform for projection onto the home;
d. saving the lighting display onto memory;
e. installing the lighting display into a projector for display purposes; and
f. sending the projector to a user.

2. The method according to claim 1, where the portable electronic device is a smartphone or a tablet.

3. The method according to claim 1, where the lighting display is adapted for modification after the step of installing the lighting display.
